(19) United States
(12) Patent Application Publication
(10) Pub. No.: US 2015/0343548 A1
(43) Pub. Date: Dec. 3, 2015

(54) METHOD FOR JOINING WIRE

(71) Applicant: GM GLOBAL TECHNOLOGY OPERATIONS LLC, Detroit, MI (US)

(72) Inventors: Richard J. Skurkis, Lake Orion, MI (US); Nilesh D. Mankame, Ann Arbor, MI (US); Nicholas W. Pinto, IV, Ferndale, MI (US)

(73) Assignee: GM GLOBAL TECHNOLOGY OPERATIONS LLC, Detroit, MI (US)

(21) Appl. No.: 14/291,606

(22) Filed: May 30, 2014

(51) Int. Cl. B23K 9/007

(52) U.S. Cl. CPC B23K 9/007

(57) ABSTRACT

A method of joining wire includes preparing a first discrete region of a first wire at a first end of the first wire. The prepared first discrete region is welded to a component to form a joint such that material of the prepared first discrete region at least partially thickens the joint. The component is one of a second end of the first wire, an end of a second wire, or a non-wire component. The joint may be heat treated according to a three-stage heat treatment process. Mechanical stress may be induced in the joint during the heat treatment so that the joint is subjected to thermo-mechanical processing.

### STATEMENT REGARDING FEDERALLY-SPONSORED RESEARCH OR DEVELOPMENT

This invention was made with Government support under Award No. 25A2034, awarded by Advanced Research Projects Agency-Energy (ARPA-E), U.S. Department of Energy. The United States Government has certain rights in this invention.

### TECHNICAL FIELD

The present teachings generally include a method for joining wire by welding, including shape memory alloy wire, and post welding annealing of the joined wire.

### BACKGROUND

Welding the end of a wire requires proper alignment of the wire end to the component to which it is to be welded. Alignment is most difficult when joining one wire end to another wire end, especially if the wire is relatively thin. Welding modifies the microstructure of the wire material at and surrounding the weld joint in a manner that can affect the strength and fatigue life of the joint. For example, welding typically enlarges grain size and leaves residual stresses in the joint. Additionally, if the wire is a shape memory alloy material, exposure of the wire to heat during the joining process can trigger the shape memory effect of the wire, causing the wire to contract at the weld area. This can affect alignment and weld strength.

Active material wires have been used as actuators, such as in a waste heat recovery engine, utilizing the high temperature of waste heat to activate the reversible phase change in the material resulting in useful motion. Active materials include those compositions that can exhibit a change in stiffness properties, shape and/or dimensions in response to an activation signal, which can be an electrical, magnetic, thermal or a like field depending on the different types of active materials. Active materials include but are not limited to the class of shape memory materials, and combinations thereof. Shape memory materials, also sometimes referred to as smart materials, are materials or compositions that have the ability to remember their original shape, which can subsequently be recalled by applying an external stimulus (i.e., an activation signal). As such, deformation of the shape memory material from the original shape can be a temporary condition.

The ability of shape memory materials to return to their original shape upon the application of external stimuli has led to their use in actuators to apply force resulting in desired motion. Smart material actuators offer the potential for a reduction in actuator size, weight, volume, cost, noise and an increase in robustness in comparison with traditional electromechanical and hydraulic means of actuation.

### SUMMARY

A method of joining wire overcomes the difficulties of joining wire ends by preparing the ends prior to welding. Moreover, the method enables post-weld heat treatment of the weld joint without moving the welded joint from its welding position, thus protecting the joint from damage when it is at its weakest. The method may be used when joining two ends of a wire to one another, an end of a first wire to an end of a second wire, or to join an end of a wire to a non-wire component.

Specifically, the method includes preparing a first discrete region of a first wire at a first end of the first wire. The prepared first discrete region is welded to a component to form a joint such that material of the prepared first discrete region at least partially thickens the joint. The component is one of a second end of the first wire, an end of a second wire, or a non-wire component. If the component is a second end of the first wire or an end of a second wire, then that end is also prepared as a second discrete region prior to welding, and the first discrete region is welded to the second discrete region.

Preparing the first discrete region includes heating the first discrete region. In one embodiment, the first end is heated sufficiently to melt the material at the first end such that the first discrete region is enlarged relative to a first adjacent portion of the wire prior to welding. For example, the melted material may cool so that the first discrete region is substantially rounded, and may be referred to as a “balled end.” If the wire is a thermally-activated shape memory alloy, melting the material is at a temperature above an austenite finish temperature of the material. Melting and re-solidification of the material typically results in a recrystallized microstructure at and near the balled end that does not exhibit the shape memory effect. Therefore, contraction of the wire due to the shape memory effect at the first end occurs when preparing the first discrete region, rather than during welding. Undesirable effects on alignment of the first end with the second end and on weld strength due to contraction during welding are thus avoided. Moreover, when both ends are prepared as the enlarged discrete regions, and have a substantially rounded shape, the discrete regions will contact one another at a single contact point, or at least at a reduced contact area in comparison to unprepared or nominally squared off wire ends pressed together. Proper pre-welding alignment is easier to achieve in this instance. It is relatively much more difficult to get wires with unprepared or nominally squared off ends to align properly and press against each other with sufficient stress in the presence of normal variations in the process of preparing the ends. Even in an embodiment in which the wire material is not a shape memory alloy, the enlarged discrete region reflows during welding to form the weld joint. Because the enlarged discrete region has a greater amount of material than the end of the wire would without preparation of the enlarged discrete region, the weld joint is thicker and prevents necking of the joint.

In an alternative embodiment, assuming the wire is a shape memory alloy material, the end can be prepared by heating above the austenite finish temperature so that the material at the end transitions from the martensite phase to the austenite phase prior to welding. In this instance, the wire would not be heated high enough to melt the material, as it would in the embodiment in which the enlarged, rounded ends are formed.

The first end of the wire and the second end of the same wire, the end of a second wire, or a non-wire component may be secured in the aligned positions prior to preparing the discrete regions and welding. For example, prior to aligning, the wire may be secured to a first base near the first end, and the second end of the same wire, the end of a second wire, or a non-wire component may be secured to a second base. One of the first base and the second base is movable along a first and a second axis perpendicular to one another, such as an X-axis and a Y-axis, and the other of the first base and the second base is movable along a third axis perpendicular to both the first axis and the second axis, such as a Z-axis, and is also movable around the second axis (i.e., to angularly adjust the relative position of the base. The wire is secured so that the first axis is parallel to a longitudinal axis of the first wire at the first end. Aligning the first end of the first wire under the method can be by moving the first base and moving the second base as necessary. Moving the bases can be controlled and coordinated by a controller.

After welding is completed, the method may include heat treating the joint by a three-stage process. In a first stage, the joint is warmed above a first predetermined temperature. In a second stage, the joint is heated sufficiently to relieve residual internal stresses, refine the grain size or provide uniformity in the grain size. In a third stage, the joint is permitted to cool to a predetermined second temperature. Each of the stages may occur with the wire remaining in the same position as the welding position. That is, the wire, and the second wire or non-wire component in some embodiments, may remain secured to the bases, and need not be moved to a dedicated heat treatment chamber. To accomplish this, the method may include moving a switch in order to establish an electrical circuit from a heating apparatus to the wire through electrically-conductive plates used to secure the wire to the bases. The joint is thus heated by resistive heating. Joints formed according to the method, including the post-weld heat-treating, have been found to have increased strength and longer fatigue life in comparison to a wire loop having two ends welded to one another without preparing the discrete regions and without the post-weld heat treatment process. After annealing, the method may include drawing the wire to modify the wire diameter, increase its strength through cold-working and impart shape memory properties to the material at the joint and in the adjacent heat affected region.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic illustration in perspective view of an assembly for joining wire by welding.

FIG. 2 is a schematic illustration in fragmentary plan view of a portion of the assembly of FIG. 1.

FIG. 3 is a schematic illustration in fragmentary plan view of a portion of the assembly of FIG. 1 showing a hot air gun for preparing discrete regions of the wire ends.

FIG. 4 is a schematic illustration in fragmentary plan view of a portion of the assembly of FIG. 1 showing a first wire with two ends to be welded to one another to form a loop.

FIG. 5 is a schematic illustration in fragmentary plan view of a portion of the assembly of FIG. 1 showing a first and a second wire having ends to be joined to one another.

FIG. 6 is a schematic illustration in fragmentary plan view of a portion of the assembly of FIG. 1 showing a first wire to be joined to a non-wire component.

FIG. 7 is a schematic illustration in fragmentary plan view of a portion of the assembly of FIG. 1 showing preparation of an enlarged discrete region at the end of a wire.

FIG. 8 is a schematic illustration in fragmentary plan view of a portion of the assembly of FIG. 7 showing the wire after preparation of enlarged discrete regions at both ends of the wire.

FIG. 9 is a schematic illustration in fragmentary plan view of a portion of the assembly of FIG. 8 showing the wire after the enlarged discrete regions are pressed to one another.

FIG. 10 is a schematic illustration in fragmentary plan view of a portion of the assembly of FIG. 8 showing welding of the wire at the discrete regions.

FIG. 11 is a schematic illustration in fragmentary plan view of a portion of the assembly of FIG. 10 showing additional welding of the wire at the discrete regions.

FIG. 12 is a schematic illustration in fragmentary plan view of a portion of the assembly of FIG. 1 showing preparation of discrete regions by heating the ends of a wire.

FIG. 13 is a schematic illustration in fragmentary plan view of a portion of the assembly of FIG. 12 showing the wire after the prepared discrete regions are pressed to one another.

FIG. 14 is a schematic illustration in fragmentary plan view of a portion of the assembly of FIG. 13 showing welding of the wire at the discrete regions.

FIG. 15 is a schematic illustration in fragmentary plan view of a portion of the assembly of FIG. 14 showing additional welding of the wire at the discrete regions.

FIG. 16 is a plot of current and temperature of the welded joint versus time during post-welding annealing of the joint by a three-phase heat treatment.

FIG. 17 is schematic illustration in side view of a completed wire loop of FIG. 11 or 15 after the heat treatment of FIG. 16.

FIG. 18 is a schematic illustration in side view of the wire loop of FIG. 17 after a drawing procedure to thin the wire.

FIG. 19 is a flow chart of a method of joining wire.

### DETAILED DESCRIPTION

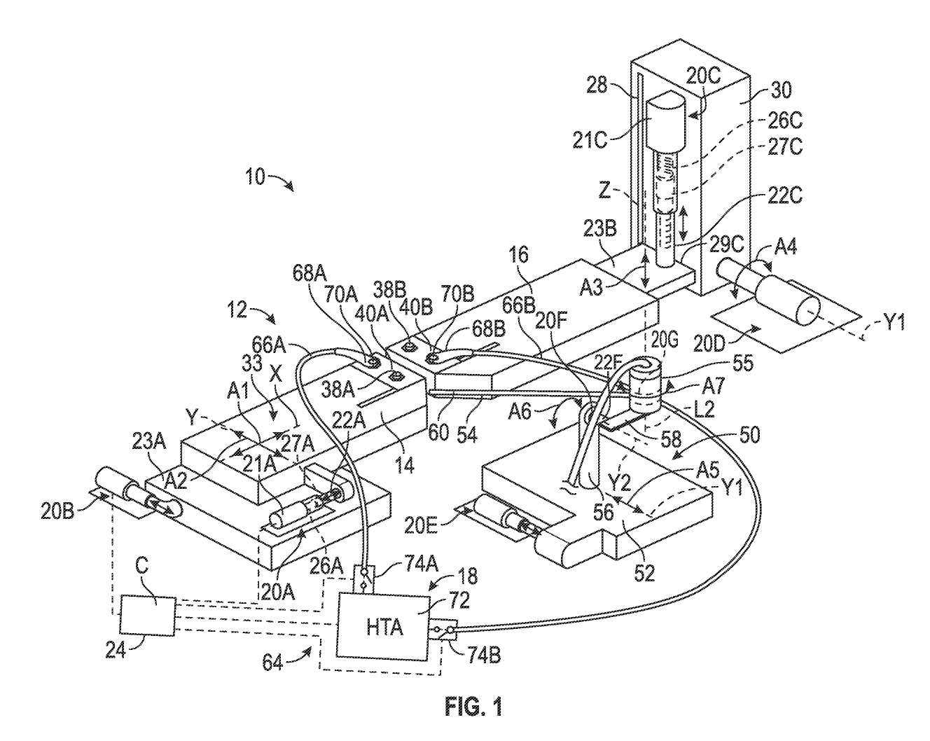

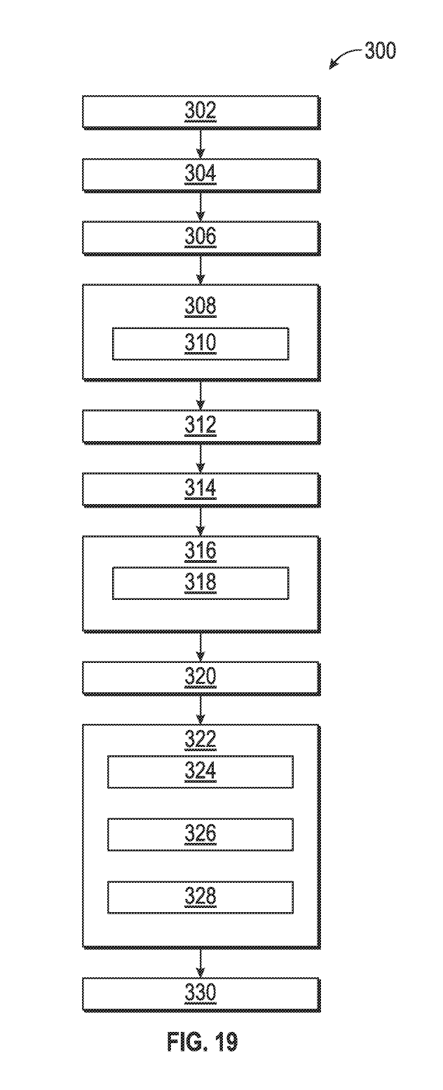

Referring to the drawings, wherein corresponding reference numbers refer to corresponding components throughout the views, FIG. 1 shows an assembly 10 used in a method 300 of joining wire shown in a flow diagram in FIG. 19. As discussed herein, the method 300 is especially useful when welding a wire that is a shape memory alloy material, but the method can be used with wires that are not made of a shape memory alloy material. By preparing the end of the wire prior to welding the end wire to itself, to another wire, or to a non-wire component, welding issues specifically exacerbated by the use of relatively thin wire and/or by the use of shape memory alloy wire are resolved.

Integrated Welding and Optional Post-Welding Heat Treatment Assembly

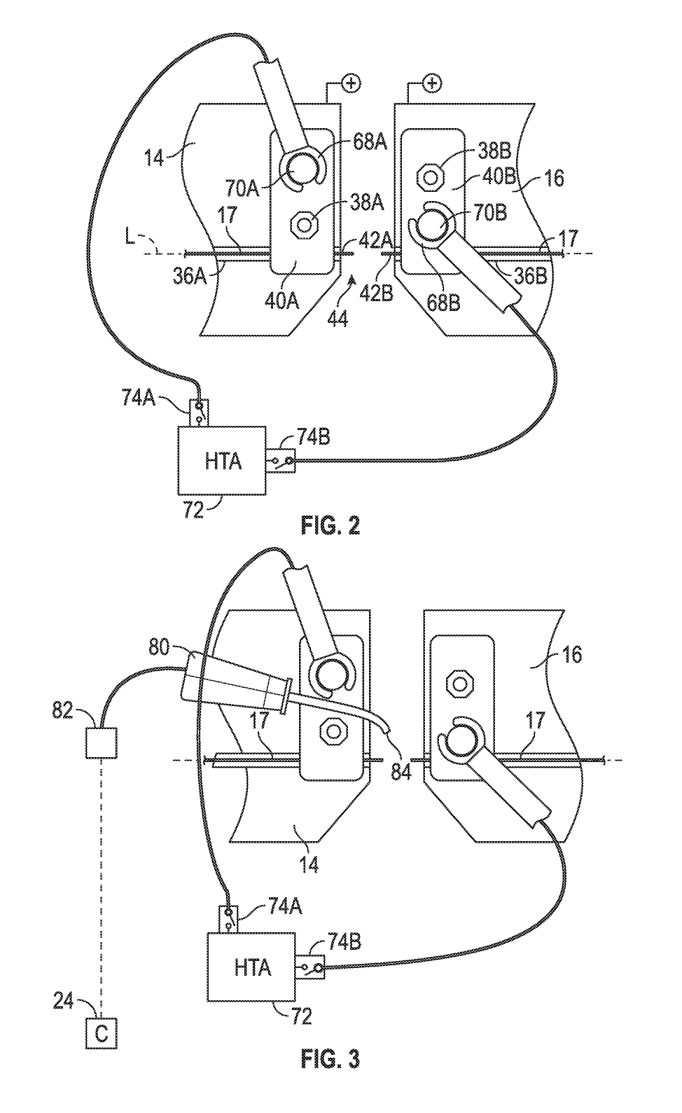

FIG. 1 shows the assembly 10 includes a welding station 12 that includes a first base 14 and a second base 16, which may also be referred to as stages. A wire 17 shown in FIG. 2 is secured to the first and second bases 14, 16 in preparation for welding the ends of the wire to one another to form a loop. The first and second bases 14, 16 are movable to align the ends of the wire with one another prior to welding. Additionally, the assembly 10 includes an optional post-weld heat treating apparatus 18 that allows the welded wire to remain secured to the bases 14, 16, in a weld position, during post weld heat treatment, thereby avoiding movement of the weld joint when it is in its weakest state.

The first base 14 is movable in two opposing directions along a first axis selected as an X-axis and labelled “X” as indicated by the double-sided arrow A1. An actuator 20A having an extendable shaft 22A (also referred to as a sliding post) secured to the base 14 can be controlled by the controller “C” 24 to move the base 14 in opposing directions along the X-axis. The actuator 20A is a lead screw actuator having an electric motor 21A that turns a lead screw 26A to move a nut 27A and the sliding post 22A linearly. The post 22A is connected to the nut 27A and the base 14 such that movement of the post 29A moves the base 14. Those skilled in the art will readily understand the function of a lead screw actuator. Any other suitable actuator can instead be used.

The first base 14 is also movable in two opposing directions along a second axis perpendicular to the first axis in a plane that includes an upper surface 33 of the base 14. The second axis is selected as a Y-axis and labeled “Y” as indicated by the double-sided arrow A2. Another lead screw actuator 20B similar to lead screw actuator 20A is secured to an extension 23A of the base 14 and can be controlled by the controller 24 to move the base 14 in opposing directions along the Y-axis. The actuator 20B can be a lead screw actuator or any other suitable actuator. Optionally, an additional linear actuator could be provided to move the first base 14 linearly along a Z-axis.

The second base 16 is movable in two opposing directions along a third axis selected as a Z-axis and labeled “Z” as indicated by the double-sided arrow A3. The Z-axis is perpendicular to both the X-axis and the Y-axis. Another actuator 20C is mounted to a support housing 30. The actuator 20C can be a lead screw actuator similar to lead screw actuator 20A, having an extendable shaft 22C (also referred to as a sliding post) and an electric motor 21C or any other suitable actuator. The electric motor 21C can turn a lead screw 26C to move a nut 27C and the sliding post 22C linearly. An extension 23B of the base 16 has a post 25 extending therefrom and captured in a track 28 of the support housing 30. Optionally, the second base 16 can also be made movable along an axis parallel with the X-axis, and/or along an axis parallel with the Y-axis.

The second base 16 is movable angularly about the Y-axis as indicated by the double-sided arrow A4. An actuator 20D having an extendable shaft 22D can be controlled by the controller 24 to move the base 16 angularly about the Y-axis. The extendable shaft 22D is secured to the housing 30 and moves the housing 30 about the Y-axis, thereby moving the second base 16 and the extension 23B therewith.

With reference to FIG. 2, a portion of a first wire 17 is placed in a V-shaped groove 36A formed in the first base 14. The V-shape of the groove 36A ensures that the wire 17 settles at the bottom of the groove 36A and is therefore centered in the groove 36A. A set screw 38A is tightened to capture the wire 17 in the groove 36A between the first base 14 and a conductive plate 40A. The set screw 38A extends through the plate 20A into the base 14. A first end 42A of the first wire 17 extends from the first base 14 into an area 44 between the first base 14 and the second base 16. Similarly, the component to which the first end 42A is to be welded is secured to the second base 16. In FIG. 2, the component is a second end 42B of the same first wire 17. The second base 16 also has a V-shaped groove 36B. A set screw 38B is tightened to capture the wire 17 in the groove 36B between the second base 16 and a conductive plate 40B. The set screw 38B extends through the plate 40B into the second base 16. A second end 42B of the first wire 17 extends from the second base 16 into the area 44. The wire 17 is shown in fragmentary view in FIG. 2. The remainder of the wire 17 rests outside of the grooves 36A, 36B, as shown in FIG. 1.

Once the wire 17 is secured to the bases 14, 16 by the conductive plates 40A, 40B either or both of the bases 14, 16 can be moved by the actuators 20A, 20B, 20C, 20D so that the first end 42A is aligned with the second end 42B along the longitudinal axis L of the wire 17 at the first end 42A. The assembly 10 includes a welding apparatus 50 movable in opposing directions along an axis Y1 (Y1-axis) as shown by the double-sided arrow A5. The weld probe apparatus 50 can be a micro pulse arc welder, a laser welder, or another type of welder suitable for relatively high throughput applications. The Y1-axis is parallel with the Y-axis. A lead screw linear actuator 20E is secured to a base 52 of the welding apparatus 50 and can be controlled by the controller 24 to move the base 52 in a direction along the Y1-axis. Alternatively, any other suitable linear actuator could be used.

A weld electrode 54 is supported on the base 52 via a probe housing 55 mounted on a post 56 and a bracket 58 secured to a shaft 22F of an angular actuator 20F. The actuator 20F is controllable by the controller 24 to rotate the shaft 22F about an axis Y2 that extends through the shaft 22F as shown by the double-sided arrow A6. The weld electrode 54 and weld tip 60 are thus rotated about the Y2-axis by the actuator 20F. Another angular actuator 20G can be secured to the bracket 58 and to the housing 55 to rotate the housing 55 relative to the bracket 58 about an axis L2 as shown by the double-sided arrow A7. The actuators 20F, 20G and/or additional actuators may also be capable of rotating the weld electrode 54 about a local axis that is parallel to the X-axis. This allows an operator or a robot to adjust the electrode 54 to maintain good visibility of the joint region especially when rotating the wire 17 after the first weld. Dashed lines in FIG. 1 are shown as representative of connections of the controller 24 to some of the actuators 20A, 20B. The connection may be via electrical wires, or the connection may be wireless. Although similar dashed lines are not shown for purposes of clarity in FIG. 1, all of the actuators 20C, 20D, 20E, 20F, 20G are operatively connected to the controller 24.

Accordingly, the position of the weld electrode 54 can be adjusted by the actuators 20E, 20F, 20G so that the weld tip 60 can be positioned at the first end 42A, and at the second end 42B, as described herein. Motion of the actuators 20E, 20F, 20G can be synchronized and controlled by the controller 24 to compensate for the change in length of the electrode 54 as it wears. During welding, the weld electrode 54 contacts the wire 17 enabling a first welding circuit to be formed, with electrical current flow from the weld tip 60 through the wire 17 and grounded to the bases 14, 16. The one or more switches 74A, 74B described herein are open during welding. Optionally, the bases 14, 16 can be supported on a common underlying base (not shown) and an actuator can be controlled to turn the common base about an axis L extending through the axis of the wire 17, shown in FIG. 2, allowing the operator to inspect the weld joint and/or access completely around the wire ends 42A, 42B.

With continued reference to FIG. 1, the assembly 10 includes a heat treatment apparatus (HTA) 64, also referred to as an annealing apparatus, which is integrated with the welding station 12 to allow post-welding heat treatment of the weld joint after welding without moving the weld joint. This prevents moving the weld joint when it is at its weakest. Specifically, electrical leads 66A, 66B are clamped to the conductive plates 40A, 40B via end clamps 68A, 68B clamped to conductive fasteners 70A, 70B that extend through the plates 40A, 40B into the bases 14, 16. If the electrical leads 66A, 66B are connected to the same terminal of an electrical power source, then the electrode 54 is electrically grounded, and vice versa, in order to complete an electrical circuit for welding. A current-limited power source 72 of the heat transfer apparatus 64 is selectively connected to the conductive plates 40A, 40B, respectively, when electrical switches 74A, 74B are selectively closed by the controller 24 after welding, creating an electrical circuit (also referred to herein as a second circuit) from the power source 72 through the leads 66A, 66B and the conductive plates 40A, 40B to the wire 17 and grounded through the bases 14, 16. The closed position of the switches 74A, 74B is shown with dashed lines. When the switches 74A, 74B are in the open position shown in solid, the second circuit from the heat treatment apparatus 64 is incomplete, and no power can flow through the leads 66A, 66B. For example, the switches are open during welding of the wire 17. Although two switches 74A, 74B are shown in FIG. 1, in other embodiments, only one switch 74A, 74B is used.

The electrical power flow in the second circuit heats the wire in the weld joint and the region adjacent to the ends 42A, 42B after the ends are welded to one another. For example, in an embodiment having only switch 74A, during heat treatment and with reference to FIG. 11, current flows from the power source 72 through the portion of the wire 17 adjacent to the weld joint J1 (i.e., left portion of wire 17 in FIG. 11), through the weld joint J1 and the portion of the wire 17 on the right of the weld joint J1 in FIG. 11, and is grounded through the bases 14, 16. Current does not flow in the remainder of the wire 17 as the resistance of that length is much higher than the portions near the weld joint J1. The weld joint is shown in FIG. 11 as joint J1 and in FIG. 15 as joint J2. The controller 24 includes a micro-ohm meter and controls the amount of current provided by the power source 72 to control the heating of the wire 17 according to three stage heat treatment of the weld joint, as discussed herein.

Pre-Welding Preparation of Wire End

Welding the end of a relatively thin diameter wire is inherently difficult for a number of reasons. First, if the wire end is to be welded to another end of the same wire, or to an end of a second wire, it is difficult to align the wire ends along a single longitudinal axis. A misalignment may cause a slight kink in the wire at the joint, and it may be difficult to completely remove the kink even with post welding drawing or straightening processes. In other words, misalignment can prevent a C¹ continuity (i.e., zero change in slope along the length of the wire at the joint). Alignment may also be affected by twisting of the wire ends 42A, 42B during processing. Achieving proper alignment is challenging when working with thin wires, regardless of their material. By way of non-limiting example only, the wire 17 and wire 17A discussed herein may have a diameter D1 in the range of 0.08 inches to 0.20 inches prior to processing according to the method 300.

Additionally, if the wire 17 is a shape memory alloy, the intense heat of welding will trigger the shape memory effect in the wire, causing the wire to contract, thereby pulling the end of the wire away from the component to which it is to be welded. This contraction can contribute to a thinning of the weld region, affecting its strength.

Shape memory alloys are alloy compositions with at least two different temperature-dependent phases. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is often called the austenite finish temperature (A_{f}). When the shape memory alloy is in the austenite phase and is cooled, it begins to change into the martensite phase, and the temperature at which this phenomenon starts is often referred to as the martensite start temperature (Mₛ). The temperature at which austenite finishes transforming to martensite is often called the martensite finish temperature (M_{f}). The range between Aₛ and A_{f} is often referred to as the martensite-to-austenite transformation temperature range while that between Mₛ and M_{f} is often called the austenite-to-martensite transformation temperature range. It should be noted that the above-mentioned transition temperatures are functions of the stress experienced by the shape memory alloy sample. Generally, these temperatures increase with increasing stress. In view of the foregoing properties, deformation of the shape memory alloy is preferably at or below the austenite start temperature (at or below Aₛ). Subsequent heating above the austenite start temperature causes the deformed shape memory material sample to begin to revert back to its original (nonstressed) permanent shape until completion at the austenite finish temperature. Thus, a suitable activation input or signal for use with shape memory alloys is a thermal activation signal having a magnitude that is sufficient to cause transformations between the martensite and austenite phases.

The temperature at which the shape memory alloy remembers its high temperature form (i.e., its original, nonstressed shape) when heated can be adjusted by slight changes in the composition of the alloy and through thermo-mechanical processing. In nickel-titanium shape memory alloys, for example, it can be changed from above about 100 degrees Celsius to below about −100 degrees Celsius. The shape recovery process can occur over a range of just a few degrees or exhibit a more gradual recovery over a wider temperature range. The start or finish of the transformation can be controlled to within several degrees depending on the desired application and alloy composition. The mechanical properties of the shape memory alloy vary greatly over the temperature range spanning their transformation, typically providing shape memory effect and superelastic effect. For example, in the martensite phase a lower elastic modulus than in the austenite phase is observed. Shape memory alloys in the martensite phase can undergo large deformations by realigning the crystal structure arrangement with the applied stress. The material will retain this shape after the stress is removed.

Suitable shape memory alloy materials include, but are not intended to be limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order so long as the alloy composition exhibits a shape memory effect, e.g., change in shape, orientation, yield strength, flexural modulus, damping capacity, superelasticity, and/or similar properties. Selection of a suitable shape memory alloy composition depends, in part, on the temperature range of the intended application. The recovery to the austenite phase at a higher temperature is accompanied by very large (compared to that needed to deform the material) stresses which can be as high as the inherent yield strength of the austenite material, sometimes up to three or more times that of the deformed martensite phase.

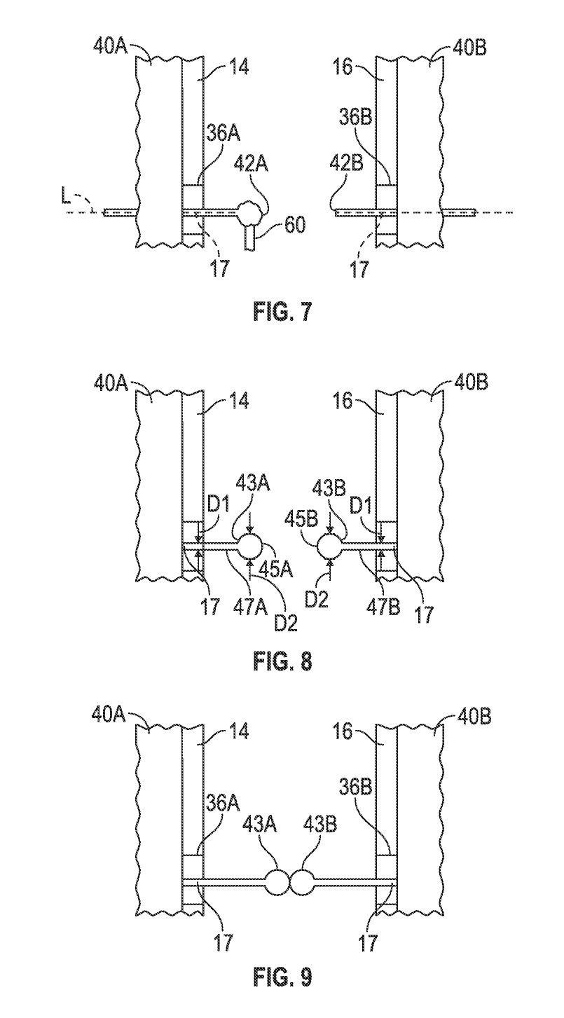

FIGS. 2 and 3 show components to be used in alternative pre-welding preparation of discrete regions at the wire ends 42A, 42B that may be carried out under the method 300. In FIG. 2, the welding apparatus 50 is used to create discrete regions (shown in FIG. 7) that are enlarged relative to adjacent portions of the wire 17. Specifically, referring to FIG. 7, when the weld tip 60 is applied to the first end 42A of the wire 17, the material of the wire 17 melts due to the heat generated by the arc created by the electrical pulse, forming an enlarged first discrete region 43A that is generally rounded when the melted material cools to room temperature, as shown in FIG. 8, and is larger in diameter D2 than a first diameter D1 of the wire 17 at a first adjacent portion 47A of the wire 17. The electrode 54 is capable of heating the material above its melting temperature, which may be approximately 600 degrees Celsius for a shape memory alloy wire. The diameter of end 42A was also diameter D1 prior to preparation of the first discrete region 43A. A similar second discrete region 43B is formed at the second end 42B. The second discrete region 43B is larger in diameter D2 relative to a diameter D1 of a second adjacent portion 47B of the wire 17. The diameter of end 42B was also diameter D1 prior to preparation of the second discrete region 43B. It is assumed for purposes of illustration that the diameters of the discrete regions 43A, 43B are equal, and that the diameters of the adjacent portions 47A, 47B are equal, but the diameters can be different within the scope of the present teachings.

If the wire is a shape memory alloy, the material of the discrete regions 43A, 43B may be a combination of the material of the weld probe 60 and shape memory alloy material. The intense heat of the process to form the discrete regions may modify the composition and/or the microstructure of the material at the joint and the adjacent region in a manner that results in the affected material not exhibiting shape memory behavior after the process is complete. However, during the formation of the discrete regions 42A, 42B, the wire 17 will undergo a shape memory effect induced contraction along its longitudinal axis L, moving the discrete regions 43A, 43B slightly away from one another, as shown in FIG. 8.

Regardless of the material of the wire 17, i.e., if the wire 17 is a shape memory alloy or is not a shape memory alloy, formation of the first and second discrete regions 43A, 43B provides additional benefits. First, the enlarged, rounded surfaces of the discrete regions 43A, 43B ensure that contact between the discrete regions 43A, 43B will be at single contact points such as contact points 45A, 45B that are approximately collinear with the clamped parts of the wires 17. In comparison, a wire with unprepared or nominally squared off ends results in an initial contact region whose extent and location relative to the wire axis are uncertain. Assuming a constant, predetermined force is used to place the wire end in contact with the component to which it is to be welded, this uncertainty in the initial contact region results in a possible local deflection of the clamped end of the wire which leads to a poor alignment of the wire at the joint. In FIG. 9, the first discrete region 43A is shown after the base 14 is moved along the X-axis to press the first discrete region 43A into contact with the second discrete region 43B at the contact points 45A, 45B indicated in FIG. 8.

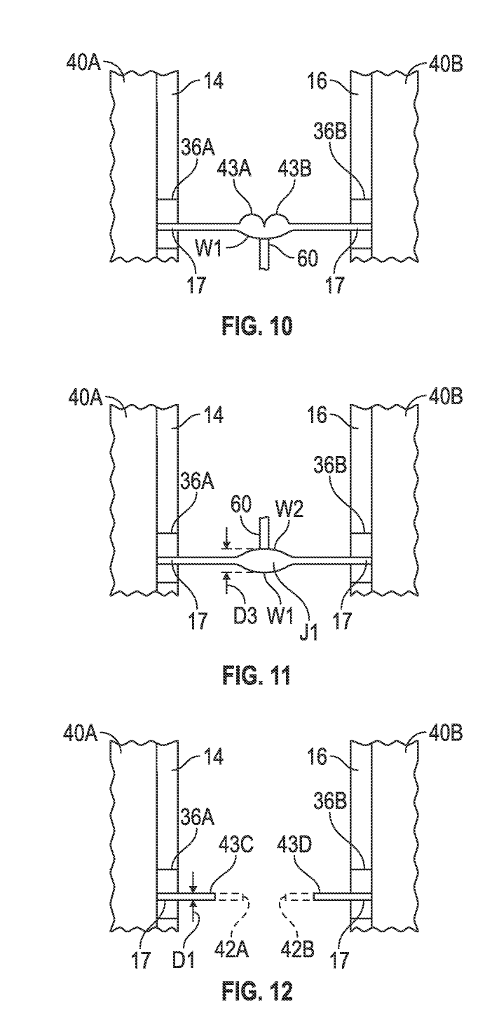

Another additional benefit of preparing the ends 42A, 42B of the wire 17 by heating the ends 42A, 42B to melt the material, forming discrete regions 43A, 43B, is that the additional material of the enlarged discrete regions 43A, 43B flows into and partially forms the weld joint when the discrete regions 43A, 43B are welded to one another, at least partially thickening the weld joint relative to a weld joint formed at ends of the same size wire not having the prepared discrete regions. This is especially beneficial in the case of a shape memory alloy wire 17 as any additional contraction due to shape memory effect that may occur in the discrete regions 43A, 43B or in the immediately adjacent wire portions 47A, 47B can be compensated for by the material of the discrete regions 43A, 43B acting as a reservoir to fill in any enlarged span between the discrete regions 43A, 43B, preventing necking, or a reduction in diameter of the weld joint. FIG. 10 shows the discrete regions 43A, 43B flowing into the weld joint during a first weld W1 with the weld tip 60 on one side of the abutted discrete regions 43A, 43B. If the welding apparatus 50 is a micro-pulse arc welder, Argon is provided during welding to shield the weld area and stabilize the arc. Micro-pulse welders are capable of precision joining such as by producing a joint from 0.1 to 0.5 millimeters in length, having a small heat affected zone, and have a controlled power delivery, such as a pulse shaped to provide 1, 30, and 230 Joules over 0.5, 1, and 64 millisecond periods. The resulting weld spot size is proportional to the power input and penetration of the weld is proportional to the pulse duration. If the welding apparatus 50 is a laser welder, the laser is on during welding. The weld tip 60 can then be rotated about either or all of axes L2, Y2, and an axis parallel with the X-axis, as discussed with respect to FIG. 1, to access the opposite side of the abutted discrete regions 43A, 43B to create a second weld W2, completing the weld joint J1. Alternatively, the weld tip 60 could either remain stationary or could be rotated in conjunction with rotation of the wire 17 by angular movement of the bases 14, 16 about the L1-axis if the optional actuator is provided that rotates both bases 14, 16 in this manner to place the weld tip 60 at the opposite unwelded side of the abutted discrete regions 43A, 43B in order to create the second weld W2. The overall width D3 of the joint J1 is less than the diameter D2 of the discrete regions 43A, 43B, but greater than the diameter of the D1 of the wire 17.

Alternative Pre-Welding Preparation of Wire End

If the wire 17 is a shape memory alloy, an alternative pre-weld preparation of the ends of the wire 17 can be undertaken, as shown and described with respect to FIGS. 12-15. The preparation also involves heating the first and second ends 42A, 42B of the wire 17 above the austenite finish A_{f} temperature using an auxiliary heat source, but does not involve heating the ends 42A, 42B to a temperature high enough to melt the material at the ends to form the enlarged rounded shapes of FIG. 9. In other words, the material of the discrete regions 43C, 43D formed by preparing the ends 42A, 42B will contract, but will not enlarge substantially. As shown in FIG. 3, an auxiliary heat source such as but not limited to a hot air gun 80 is supplied electrical current from a power supply 82 under the control of the controller 24 to generate hot air flow through a nozzle 84 directed at the wire ends 42A, 42B. The hot air flowing through the nozzle 84 is at a temperature not less than the austenite finish Af temperature, but sufficiently below the melting temperature of the material of the wire 17. The hot air flow is maintained to ensure that the minimum temperature in this part of the wire is maintained above Af until the welding operation is done. If a pulse arc welding process is used with Argon shielding gas, the shielding gas itself may be preheated and used to prepare the ends prior to welding.

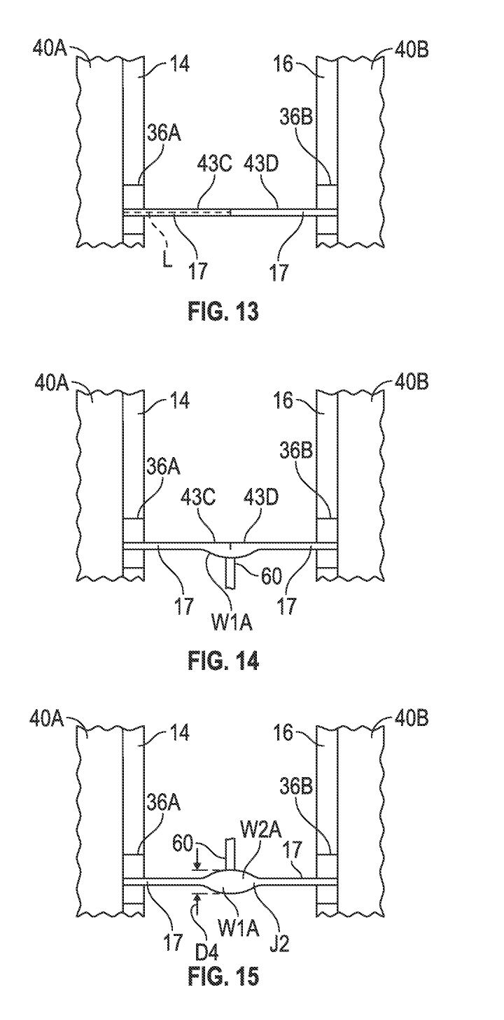

After preparation of the discrete regions 43C, 43D, the first base 14 is moved along the X-axis toward the second base 16, and may be moved along the Y-axis as necessary, while the second base 16 may be moved along the Z-axis and rotated about the Y1-axis as necessary to align the discrete regions 43A, 43B and press the discrete regions 43A, 43B into contact with one another along the longitudinal axis L, as shown in FIG. 13.

FIG. 14 shows the discrete regions 43C, 43D welded to one another with a first weld W1A with the weld tip 60 on one side of the abutted discrete regions 43C, 4CD. The weld tip 60 can then be rotated about either or both axes L2, Y2, as discussed with respect to FIG. 1, to access the opposite side of the abutted discrete regions 43C, 43D to create a second weld W2A, completing the weld joint J2. Alternatively, the weld tip 60 could either remain stationary or could be rotated in conjunction with rotation of the wire 17 by movement of the bases 14, 16 about the axis L1 if the optional actuator is provided that can rotate the bases 14, 16 in unison to place the weld tip 60 at the opposite unwelded side of the abutted discrete regions 43C, 43D in order to create the second weld W2A. The overall width D4 of the joint J2 may be greater than the diameter of the D1 of the wire 17. Because the joint J1 or J2 is relatively smooth and has a convex profile after welding, further thermo-mechanical processing such as annealing and drawing can be undertaken to improve the joint properties.

Post-Welding Heat Treatment of Weld Joint

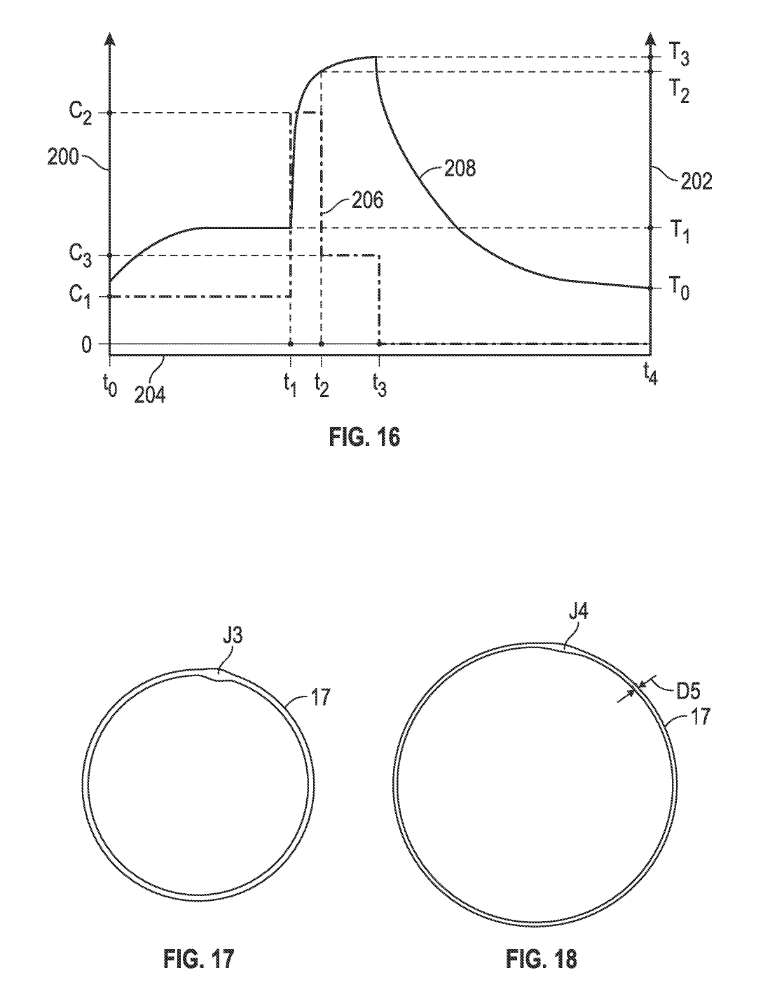

Referring to FIG. 16, the temperature of the weld joint J1 or J2 during the three-stage, post-welding heat treatment process accomplished by the HTA 64 is illustrated. Current 200 provided to the joint J1, J2 on the left-side Y-axis and temperature 202 on the right side Y-axis are plotted versus time on the X-axis. The current 202 is controlled to provide a three-stage, resistive heating-based heat treatment process resulting in the temperature profile 208 of the weld joint J1 or J2. The entire heat-treating process is accomplished in-situ, meaning that the weld joint is not moved from its welding position during the heat treatment process. The heat-treatment process begins at an initial time t₀ when the switches 74A, 74B of FIG. 2 or 3 are closed to establish a first effective magnitude of current C₁ in the second circuit during a first stage or time period from an initial time t₀ to a first time t₁. During this stage, the temperature 208 of the weld joint J1 or J2 rises from an initial temperature T0, such as a surrounding ambient temperature (i.e., room temperature) to a predetermined warmed temperature T1. The temperature T1 is greater than the austenite finish temperature and may be above 90 degrees Celsius. The time period from t₀ to t₁ is referred to as the warming stage. The effective current magnitude may be controlled directly or through pulse width modulation.

When the warmed temperature T1 is reached at time t₁, the effective magnitude of the current is increased to current level C2 and remains at current level C2 until time t₂. Determination of the temperature of the joint J1 or J2, such as the temperature T1 can be determined either by a timer set at t₀, based on prior testing correlating time of application of current to joint temperature, or by a temperature sensor operatively connected to the joint and indicative of weld temperature, such as a temperature sensor connected to the conductive clamp 40A or 40B. During the time period from t₁ to t₂, the temperature of the joint J1 or J2 rises relatively quickly to a second temperature T2. When the temperature of the joint J1 or J2 reaches temperature T2, at time t₂, the current is dropped from an effective current level C2 to an effective current level C3, where it remains until time t₃. The weld joint J1 or J2 reaches temperature T3 at time t₃. The temperature of the weld joint J1 or J2 rises much less quickly during the time period from t₂ to t₃. The time period from time t₁ to time t₃ is referred to as a second stage. The temperature T3 is high enough to relieve residual internal stresses, refine the grain size or provide uniformity in the grain size in the material at the joint J1 or J2 and the adjacent areas, and may be approximately 300 degrees Celsius.

The various stage actuators 20A-D that were used to position and align the wire with the component to which it is to be welded, can also be used to induce a desired stress at the joint during the heat treatment process. In other words, the joint may be subjected to thermo-mechanical processing. The nature (e.g. uniaxial tension or multi-axial bending) and magnitude of the stress may varied with time either independently of the various heating stages or in conjunction with them. The combination of thermal and mechanical loads provides more control over the properties of the finished joint. Load cells placed in the load path of the wire and displacement sensors on the stage actuators may be used to provide feedback to the controller for controlling and synchronizing the thermal and mechanical loads.

At time t₃ the effective current level provided in the second heating circuit drops to a low value that is chosen to result in a desired cooling rate for the material. This effective value may be zero as shown in FIG. 16 which is achieved by opening the switches 74A, 74B. The temperature of the weld joint J1 or J2 cools, such as by convection, to a predetermined temperature such as room temperature level T0. Once the weld joint J1 or J2 reaches room temperature at time t₄, the wire with the welded joint J1 or J2 can be removed from the bases 14, 16 by loosening the set screws 38A, 38B to lift the conductive plates 40A, 40B, allowing the welded wire to be removed from the grooves 36A, 36B.

Optional Post Heat-Treatment Drawing

After heat-treatment, the welded joint is referred to as joint J3, and is shown in FIG. 17. The wire 17 with joint J3 can still be thermo-mechanically processed further to provide an even thinner wire. For example, the wire 17 can be subjected to a drawing process to thin both the wire and the joint. The thinned wire is shown in FIG. 18 after the drawing process, with the both the joint and the wire 17 becoming thinner. The diameter D5 of the wire 17 after drawing will be less than the initial diameter D1 of the wire 17. The joint after the drawing process is referred to as joint J4. In one example, a weld joint J1 or J2 having a diameter of 2.15 mm was heat-treated and drawn down to 0.3 mm. In another example, a wire was drawn from 0.085 inch diameter to 0.05 inch diameter away from the joint J1 or J2. In testing, such joints have maintained their integrity while being cycled as a shape memory alloy wire loop actuator more than 1 million times at a working stress of 0.1 GPa.

Application of Method to Welding of First Wire to Second Wire or to Second Component

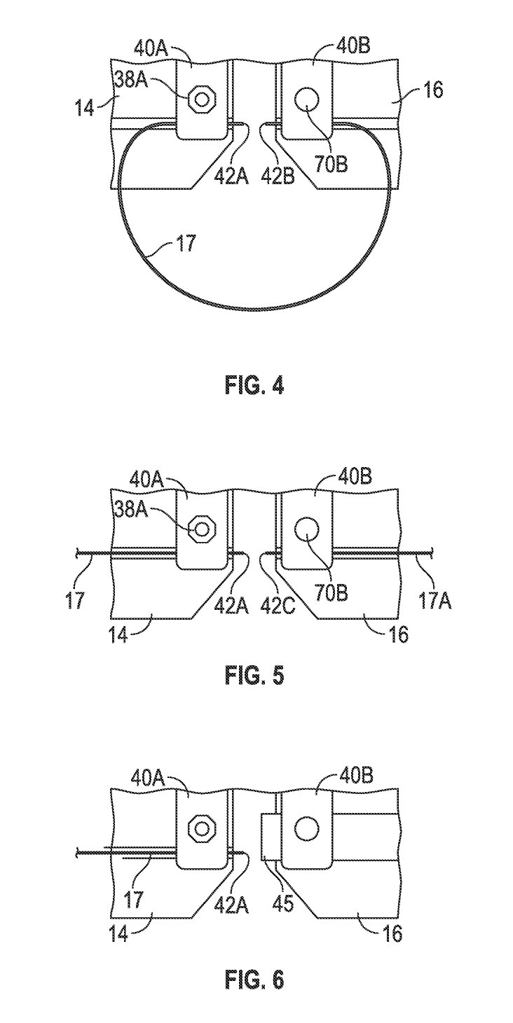

FIGS. 1-3 and 7-15 show a single wire 17 having its ends 42A, 42B joined to form a single wire loop, as further shown in FIG. 4. The method 300 described herein can be applied equally to the joining of a first end 42A of a first wire 17 to an end 42C of a separate, second wire 17A, as illustrated in FIG. 5. The alignment issues are the same as described with respect to the single wire embodiment of FIG. 4. Additionally, the method 300 can be applied to joining a first end 42A of a first wire 17 to to a non-wire component 49, shown in FIG. 6, such as a component to be actuated by the wire 17. In the case of a non-wire component, the V-shaped groove in the second base 16 would not be used, and the conductive plate 40B may need to be modified to securely hold the non-wire component 49 to the base 16.

FIG. 19 is a flow chart of the method 300 of joining wire described herein. The method 300 begins with step 302, in which the first wire 17 is secured to the first base 14. In step 304, the component to which the first end 42A of the first wire 17 is to be welded is secured to the second base 16. As discussed herein, the component may be a second end 42B of the first wire 17, a second wire 17A, or a non-wire component 45. Securing the first wire 17 to the first base 14 is by placing the wire 17 in the V-shaped groove 36A and tightening the set screw 38A to capture the wire 17 in the groove 36A between the first base 14 and a conductive plate 40A. Securing the component to the second base 16 is accomplished in a like manner.

In step 306, a discrete region of the first end 42A of the first wire 17 is prepared. The preparation may be by heating the first end 42A sufficiently to melt the material of the wire 17, resulting in an enlarged discrete region 43A which may be generally rounded. Such an enlarged discrete region may be formed whether the material of the wire 17 is a shape memory alloy or not. In either case, the enlarged discrete region 43A will be beneficial to the formation of the subsequent welded joint, as discussed herein. If the material is a shape memory alloy, melting the end 42A will necessarily increase the temperature of the end 42A above the austenite finish temperature of the material, eliminating or minimizing any shape memory effect of the material during the subsequent welding.

Alternatively, as discussed with respect to FIG. 12, if the wire 17 is a shape memory alloy, step 306 may include heating the first end 42A at least to the austenite finish temperature (e.g., approximately 90 degrees Celsius), but not to a temperature that will cause the material of the wire 17 to melt (e.g., approximately 600 degrees Celsius). In this case, the discrete region 43C prepared will have been subjected to contraction due to the shape memory effect prior to the welding step to eliminate or minimize the shape memory effect during welding. The minimum temperature in the part of the wire near the end to be joined has to be maintained above Af using the auxiliary heat source (e.g. a hot air gun) until the welding operation is completed.

Next, in step 308, the prepared discrete region 43A or 43C of the wire 17 is aligned with the component 49 or with the respective prepared discrete region 43B, 43D. The alignment may be accomplished in sub-step 310, by moving the first base 14 and/or the second base 16 using one or more of the various actuators 20A, 20B, 20C, 20D as discussed herein.

If the component to which the first end 42A is to be welded is a second end 42B of the same wire 17 or an end 42C of a second wire 17A, the method 300 may include step 312, preparing a second discrete region 43B or 43D, as discussed herein.

In step 314, following preparation of the first discrete region 43A or 43C, and in some embodiments, the second discrete region 43B or 43D, the first discrete region 43A or 43C is pressed into contact with the component to which the first wire 17 is to be welded. This may entail pressing the first discrete region 43A or 43C into contact with the second discrete region 43B or 43D, respectively, or the component 49 to which the first discrete region is to be welded. The alignment may also be adjusted as necessary after the preparation of the discrete regions in step 310 and 316 and prior to step 314, such as if the preparation step or steps cause twisting of the wire 17.

In step 316, the first discrete region 43A or 43C is welded to the component (the prepared second end of the same wire 17 or different wire 17A, or to the non-wire component 49) to create the weld joint J1 or J2. Step 316 may include multiple tacks, and may involve rotating either or both of the weld tip 60 and the wire 17 relative to one another in step 318 to allow the electrode 54 to access different sides of the wire 17.

After the joint J1 or J2 is formed, the method 300 proceeds to the post-weld heat treatment of the joint J1 or J2. First, in step 320, the second electrical circuit is established and the first one is broken by moving (i.e., closing) the switches 74A, 74B (or one of the switches 74A, 74B in embodiments where only one switch is provided) to connect the conductive plates 40A, 40B to the HTA 64. The weld joint J1 or J2 can then be heat treated in step 322 while the weld joint J1 or J2 remains in situ, i.e., in the welding position, secured to the bases 14, 16.

Annealing may be a three-step heat treatment process, in which case step 322 includes sub-step 324, warming the joint above a first predetermined temperature during a first stage; sub-step 326, heating the joint sufficiently to relieve internal stresses, refine the grain size or make the grain size more uniform in the material at and near the joint during a second stage; and sub-step 328, permitting the joint to cool to a predetermined second temperature at a predetermined rate during a third stage prior to moving the joint from a welding position. This heat treatment of the wire 17 increases the strength and fatigue life of the weld joint sufficiently so that the wire 17 may then undergo optional drawing in step 330 to thin the wire 17.

While the best modes for carrying out the many aspects of the present teachings have been described in detail, those familiar with the art to which these teachings relate will recognize various alternative aspects for practicing the present teachings that are within the scope of the appended claims.

1. A method of joining wire comprising:
preparing a first discrete region of a first wire at a first end of the first wire; and
welding the prepared first discrete region to a component to form a joint such that material of the prepared first discrete region at least partially affects a thickness of the joint; and wherein the component is one of a second end of the first wire, an end of a second wire, or a non-wire component.

2. The method of claim 1, wherein said preparing the first discrete region is by:
heating the first end sufficiently to melt the first end such that the first discrete region is enlarged relative to a first adjacent portion of the first wire prior to said welding.

3. The method of claim 2, wherein the first discrete region is substantially rounded.

4. The method of claim 2, wherein the first wire is a thermally-activated shape memory alloy material that finishes a transitions from a martensite phase to an austenite phase when heated to a temperature above an austenite finish temperature of the shape memory alloy material; wherein the shape memory material contracts when transitioned to the austenite phase; and
wherein heating the first end sufficiently to melt the first end heats the material of the first discrete region above the austenite finish temperature to transition the material of the first discrete region to the austenite phase.

5. The method of claim 1, wherein the first wire is a shape memory alloy that finishes a transition from a martensite phase to an austenite phase when heated to an austenite finish temperature; wherein the shape memory alloy contracts when transitioned to the austenite phase; wherein said preparing the first discrete region is by:
heating the first end to a temperature not less than the austenite finish temperature to thereby contract the first end of the first wire prior to the welding of the prepared discrete region; and
maintaining a temperature not less than the austenite finish temperature in a portion of the wire to be welded during said welding.

6. The method of claim 2, wherein the component is the second end of the first wire; wherein the first wire is a shape memory alloy that finishes a transition from a martensite phase to an austenite phase when heated to an austenite finish temperature; wherein the shape memory alloy contracts when transitioned to the austenite phase; and further comprising:
preparing a second discrete region of the first wire at the second end of the first wire by heating the second end to melt the second end such that the second discrete region is enlarged relative to a second adjacent portion of the first wire prior to said welding; and
wherein said welding is of the first discrete region of the first end to the second discrete region of the second end such that the first wire forms a loop.

7. The method of claim 2, wherein the component is the second end of the first wire; wherein the first wire is a shape memory alloy that finishes a transition from a martensite phase to an austenite phase when heated to an austenite finish temperature; wherein the shape memory alloy contracts when transitioned to the austenite phase; and further comprising:
preparing a second discrete region of the second end of the first wire by heating the second end to a temperature not less than the austenite finish temperature of the shape memory material to thereby contract the second end of the first wire prior to the welding of the first discrete region to the prepared second discrete region; and
maintaining a temperature not less than the austenite finish temperature in a portion of the wire to be welded during said welding.

8. The method of claim 1, further comprising:
aligning the first discrete region with the component; and
pressing the first discrete region into contact with the component to establish a welding position of the first wire.

9. The method of claim 8, further comprising:
prior to said aligning, securing the first wire to a first base;
prior to said aligning, securing the component to a second base; wherein one of the first base and the second base is movable along a first and a second axis perpendicular to one another, and the other of the first base and the second base is movable along the a third axis perpendicular to both the first axis and the second axis, and around the second axis; wherein the first axis is parallel to a longitudinal axis of the first wire at the first end;
wherein said aligning the first end of the first wire is by moving the first base and moving the second base.

10. The method of claim 8, wherein said securing the first wire is capturing the first wire within a V-shaped groove of the first base.

11. The method of claim 1, further comprising:
rotating at least one of a weld tip and the first end of the first wire relative to one another during said welding.

12. The method of claim 1, further comprising:
heat treating the joint after welding the joint.

13. The method of claim 12, wherein said annealing the joint is by a three-stage heat treatment of the joint including:
warming the joint above a first predetermined temperature during a first stage;
after the first stage, heating the joint sufficiently to relieve internal stresses, refine the grain size or make the grain size more uniform in the material at and near the joint during a second stage; and
after the second stage, permitting the joint to cool to a predetermined second temperature at a pre-determined rate during a third stage prior to moving the joint from a welding position; and further comprising:
inducing mechanical stress in the joint during said heat treating.

14. The method of claim 13, further comprising:
securing the first wire to a first base with a conductive plate prior to welding the first discrete region; wherein the conductive plate forms a portion of a weld circuit for said welding with the first wire in a welding position;
moving a switch following said welding to electrically connect the conductive plate to a heat treating apparatus as part of an annealing circuit for said annealing; and
wherein said heat treatment is with the first wire remaining in the welding position.

15. The method of claim 9, further comprising:
drawing the first wire after said welding such that a diameter of the first wire after drawing is less than a diameter of the first wire prior to welding.

16. A method of joining wire comprising:
preparing a first discrete region at a first end of a thermally-activated shape memory alloy wire having a first diameter by melting the first end such that the first discrete region is wider than the first diameter;
preparing a second discrete region at a second end of the shape memory alloy wire by melting the second end such that the second discrete region is wider than the first diameter; and
welding the first discrete region to the second discrete region to form a joint that maintains the shape memory alloy wire in a loop.

17. The method of claim 16, further comprising:
securing the first wire near the first end to a first base;
securing the first wire near the second end to a second base; wherein one of the first base and the second base is movable along a first and a second axis perpendicular to one another, and the other of the first base and the second base is movable along a third axis perpendicular to both the first axis and the second axis, and around the second axis; wherein the first axis is parallel to a longitudinal axis of the first wire at the first end;
aligning the first end of the first wire with the second end of the first wire to establish an aligned position of the wire by moving the first base and the second base;
pressing the first discrete region into contact with the second discrete region after said aligning to establish a welding position of the first wire; and
wherein said welding is after said pressing.

18. The method of claim 16, further comprising:
heat treating the joint after welding the joint; wherein said heat treating the joint has three-stages including:
warming the joint above a first predetermined temperature during a first stage;
heating the joint sufficiently to relieve internal stresses, refine the grain size or make the grain size more uniform in the material at and near the joint during a second stage; and
cooling the joint to a predetermined second temperature during a third stage; and
inducing mechanical stress in the joint during said heat treating.

19. The method of claim 18, further comprising:
securing the first wire to a first base with a conductive plate prior to welding the first discrete region; wherein the conductive plate forms a portion of a weld circuit for said welding with the first wire in a welding position;
moving a switch following said welding to electrically connect the conductive plate to a heat treatment apparatus as part of a heat treatment circuit for said annealing and to disconnect the conductive plate from a welding circuit; and
wherein said heat treating is accomplished with the first wire remaining in the welding position.
